(19) United States
(12) Patent Application Publication
(10) Pub. No.: US 2024/0396797 A1
(43) Pub. Date: Nov. 28, 2024

(54) DOCKING STATION AND DISPLAY DEVICE

(71) Applicant: Realtek Semiconductor Corporation, Hsinchu (TW)

(72) Inventors: Tzuo-Bo LIN, Hsinchu (TW); Bo Yu LAI, Hsinchu (TW); You-Wen CHIOU, Hsinchu (TW); Tien-Wei KAO, Hsinchu (TW); Yuh Wey LIN, Hsinchu (TW); Chien-Wei CHEN, Hsinchu (TW)

(21) Appl. No.: 18/669,553

(22) Filed: May 21, 2024

Related U.S. Application Data
(60) Provisional application No. 63/503,709, filed on May 22, 2023.

(30) Foreign Application Priority Data
Dec. 4, 2023 (TW) 112147111

(51) Int. Cl. H04L 41/082; G06F 3/14; H04L 69/18

(52) U.S. Cl. CPC H04L 41/082; G06F 3/14; H04L 69/18

(57) ABSTRACT

A docking station includes a network interface controller, a processor, and an output interface controller. The processor is connected to the network interface controller and the output interface controller. The network interface controller receives an operation instruction from an external control device and correspondingly translates the instruction into a communication protocol message. The processor correspondingly writes the communication protocol message into the memory of the processor to update the firmware of the docking station; or the processor correspondingly transmits the communication protocol message to the output interface controller, so that the output interface controller converts the communication protocol message into a display setting instruction and transmits the display setting instruction to display device so as to adjust display parameter of the display device.

### RELATED APPLICATIONS

This application claims priority to U.S. Provisional Application Ser. No. 63/503,709, filed May 22, 2023, and Taiwan Application Serial Number 112147111, filed Dec. 4, 2023, the disclosures of which are incorporated herein by reference in their entireties.

### BACKGROUND

### Field of Invention

The present invention relates to a docking station. More particularly, the present invention relates to a docking station with remote control function.

### Description of Related Art

The known docking station needs a physical line to connect to the device to be controlled, thereby realizing a specific function such as firmware updating or one-click sleep. Thus, in some scenarios, such as office management, the network management needs to go directly to the site to control and manage plural docking stations individually, and that is time-consuming and labor-intensive. Therefore, a different manner for accessing/controlling the docking station is required to make network management more convenient.

### SUMMARY

The present invention provides a docking station including a network interface controller, a processor, and an output interface controller. The network interface controller is configured to receive an operation instruction from an external control device and correspondingly translate the operation instruction into a first communication protocol message. The processor is connected to the network interface controller to receive the first communication protocol message. The output interface controller is connected to the processor. The processor is configured to perform the following operations according to the first communication protocol message: writing the first communication protocol message corresponding to a firmware file into a memory of the processor so as to update firmware of the docking station; or transmitting the first communication protocol message to the output interface controller, such that the output interface controller converts the first communication protocol message into a display setting instruction and transmits the display setting instruction to at least one display device connected to the output interface controller so as to adjust at least one display parameter of the at least one display device.

The present invention further provides a docking station including a network interface controller, a processor, an output interface controller, and an input interface controller. The network interface controller is configured to receive an operation instruction from an external control device and correspondingly translate the operation instruction into a first communication protocol message. The processor is connected to the network interface controller to receive the first communication protocol message. The output interface controller is connected to the processor. The input interface controller is connected an electronic device to receive a first audio-video signal from the electronic device. The processor is configured to convert the first audio-video signal into a second audio-video signal different from the first audio-video signal according to the first communication protocol message and to transmit the second audio-video signal to the output interface controller. The output interface controller transmits the second audio-video signal to at least one display device connected to the output interface controller, such that the at least one display device displays an image corresponding to the second audio-video signal.

The present invention yet provides a display device including a network interface controller, a processor, and a display and output interface controller. The network interface controller is configured to receive an operation instruction from an external control device and correspondingly translate the operation instruction into a first communication protocol message. The processor is connected to the network interface controller to receive the first communication protocol message. The display and output interface controller is connected to the processor. The processor is configured to transmit the first communication protocol message to the display and output interface controller, such that the display and output interface controller converts the first communication protocol message into a display setting instruction and transmits the display setting instruction to an external display device connected to the display and output interface controller so as to adjust at least one display parameter of the external display device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a system block diagram of a docking station according to some embodiments of the present invention.

FIG. 2 illustrates a system block diagram of an application system of the docking station according to some embodiments of the present invention.

FIG. 3 illustrates a system block diagram of an application system of the docking station according to some embodiments of the present invention.

FIG. 4 illustrates a system block diagram of a docking station according to some embodiments of the present invention.

FIG. 5 illustrates a system block diagram of an application system of a display device according to some embodiments of the present invention.

FIG. 6 illustrates a system block diagram of an application system of a display device according to some embodiments of the present invention.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. The using of “first”, “second”, “third”, etc. in the specification should be understood for identify units or data described by the same terminology, but are not referred to particular order or sequence.

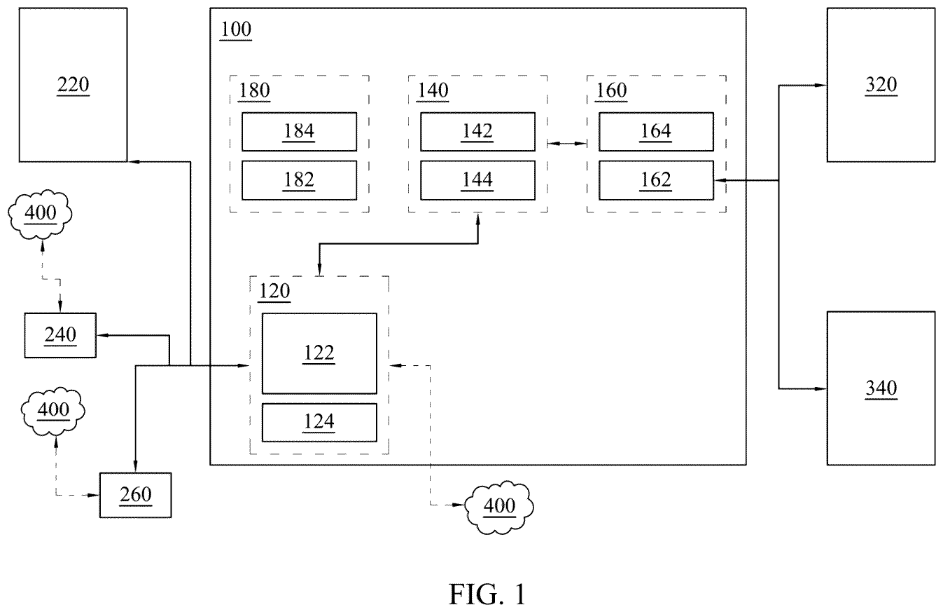

FIG. 1 illustrates a system block diagram of a docking station 100 according to some embodiments of the present invention. The docking station 100 includes a network interface controller 120, a processor 140, an output interface controller 160, and an input interface controller 180. The arrow symbols as shown in FIG. 1 are used to indicate the transmission paths of the control instructions. A communication circuit 122 of the network interface controller 120 receives an operation instruction from the external control device 220, 240 or 260 through a first transmission interface. The output interface controller 160 is communicatively connected to the display devices 320 and 340 through a second transmission interface. It should be noted that the number of the external control devices as shown in FIG. 1 is merely an example, and in fact the number of the external control devices may be less than or more than three. It should be noted that the number of the display devices as shown in FIG. 1 is merely an example, and in fact the number of the display devices may be less than or more than two.

In some embodiments of the present invention, the external control device 220 is a computer, the external control device 240 is a server, and the external control device 260 is a smart phone, but the present invention is not limited thereto. Specifically, the user can use the computer, the server or the smart phone to remotely connect to the docking station 100 so as to control the docking station 100. For example, regarding the computer or the server, the user can use the corresponding program/software to transmit the operation instruction to the network interface controller 120. For example, regarding the smart phone, the user can use the corresponding application (APP) to transmit the operation instruction to the network interface controller 120.

In some embodiments of the present invention, the first transmission interface between the communication circuit 122 of the network interface controller 120 and the external control device 220, 240 or 260 may be wireless network (WiFi) or Ethernet. In other words, the external control device 220, 240 or 260 is communicatively connected to the docking station 100 in a remote control manner through WiFi or an Ethernet. Alternatively, the first transmission interface between the communication circuit 122 and the external control device 220, 240 or 260 may be wireless communication interface, serial interface, Universal Serial Bus (USB) interface or audio-video (AV) transmission line interface, such as but not limited to: Bluetooth, ZigBee, audio input (auxiliary (AUX)), Display Data Channel/Command Interface (DDC/CI), Universal Asynchronous Receiver/Transmitter (UART), Serial Peripheral Interface (SPI), Power Delivery Configuration Channel (PD CC), Controller Area Network bus (CAN bus), Modbus protocol, Consumer Electronics Control (CEC) protocol, USB interface.

In some embodiments of the present invention, the second transmission interface between the output interface controller 160 and the display devices 320 and 340 is the audio-video transmission line interface, such as HDMI, DisplayPort (DP), USB-C, etc. In addition, in some embodiments of the present invention, the second transmission interface between the output interface controller 160 and the display devices 320 and 340 may also be inter-integrated circuit (I²C) bus interface, AUX, DDC/CI, UART, SPI, PD CC, CAN bus, Modbus protocol, CEC protocol, or USB interface.

The instruction translation circuit 124 of the network interface controller 120 translates the operation instruction into a first communication protocol message. The processor 140 is connected to the network interface controller 120 to receive the first communication protocol message. The output interface controller 160 is connected to the processor 140. The input interface controller 180 is connected to the processor 140. Specifically, the instruction translation circuit 124 transmits the translated first communication protocol message to the processing circuit 142 of the processor 140. In some embodiments of the present invention, the network interface controller 120 transmits the first communication protocol message to the processor 140 in compliance with inter-integrated circuit (I²C) protocol (i.e., the first communication protocol message is an I²C signal), but the invention is not limited thereto. For example, the network interface controller 120 may transmit the first communication protocol message to the processor 140 in compliance with the following communication interface: AUX, DDC/CI, UART, SPI, PD CC, CAN bus, Modbus, CEC protocol, or USB interface.

After the processing circuit 142 receives the first communication protocol message from the instruction translation circuit 124, the processing circuit 142 is responsible for processing the received first communication protocol message, and then performs a corresponding operation according to the first communication protocol message. The above-mentioned operation includes, but is not limited to, obtaining the current firmware version of the docking station, obtaining specific firmware operation information of the docking station (for engineering personnel to debug), obtaining the firmware development date of the docking station, updating the firmware of the docking station, obtaining the display parameters of the display device (such as resolution, color temperature, saturation, Hue, brightness, contrast, volume, etc.), adjusting the display parameters of the display device (such as resolution, color temperature, saturation, Hue, brightness, contrast, volume, etc.), controlling the display screen of the display device to turn on/off, controlling the display screen of the display device to display a darkened screen, etc.

The current firmware version of the docking station is obtained, for example, by the following steps. (S11) The external control device 220, 240 or 260 utilizes a corresponding program to transmit a reading instruction (for obtaining the current firmware version) to the communication circuit 122. (S12) The instruction translation circuit 124 translates the reading instruction into a second communication protocol message (for obtain the current firmware version) and transmits the second communication protocol message to the processor 140. (S13) The processing circuit 142 receives the second communication protocol message (for obtaining the current firmware version) and correspondingly sends back the current firmware version message to the external control device 220, 240 or 260 through the network interface controller 120, such that the external control device 220, 240 or 260 acquires the current firmware version of the docking station 100. In some embodiments of the present invention, in the above-mentioned step S12, the second communication protocol message is an I²C signal.

The firmware of the docking station is updated, for example, by the following steps. First, the steps (S11), (S12), and (S13) are performed so that the external control device 220, 240, or 260 acquires the current firmware version of the docking station 100 and then decides whether to update the firmware of the docking station 100. It is worth mentioning that if the external control device 220, 240 or 260 has confirmed in advance that the current firmware version of the docking station 100 is not the latest, it is not necessary to perform the steps (S11), (S12), and (S13) at first. Then, the following steps are performed. (S14) The external control device 220, 240 or 260 loads the pre-prepared firmware file into the corresponding program. (S15) The communication circuit 122 receives an operation instruction corresponding to the pre-prepared firmware file from the external control device 220, 240 or 260, and the instruction translation circuit 124 translates the operation instruction into a first communication protocol message corresponding to the pre-prepared firmware file. (S16) The processing circuit 142 receives the first protocol message corresponding to the pre-prepared firmware file and writes the first protocol message into the memory 144 of the processor 140 to update the firmware of the docking station 100. In some embodiment of the present invention, in the above-mentioned step S15, the first communication protocol message is an 12C signal.

The display parameters of the display device are obtained, for example, by the following steps. (S21) The external control device 220, 240 or 260 utilizes a corresponding program to transmit a reading instruction (for obtaining the display parameters) to the communication circuit 122. (S22) The instruction translation circuit 124 translates the reading instruction into a first communication protocol message (for obtaining the display parameters). (S23) The processing circuit 142 receives the first communication protocol message (for obtaining the display parameters) and converts the first communication protocol message into a display reading instruction (for obtaining the display parameters). (S24) The processing circuit 142 transmits the display reading instruction (for obtaining the display parameters) to the instruction circuit 162 of the output interface controller 160. The instruction circuit 162 transmits the display reading instruction (for obtaining the display parameters) to the display device 320 and/or 340, such that the display parameter signal is correspondingly read back from the display devices 320 and/or 340. (S25) The processing circuit 142 receives the display parameter signal from the instruction circuit 162 and translates the display parameter signal into a second communication protocol message. (S26) The communication circuit 122 receives the second communication protocol message from the processor 140 and transmits the second communication protocol message to the external control device 220, 240 or 260, such that the external control device 220, 240 or 260 acquires the display parameters of the display device 320 and/or 340 (such as resolution, color temperature, saturation, Hue, brightness, contrast, volume, etc.).

In some embodiments of the present invention, in the above-mentioned step S25, the second communication protocol message is also an I²C signal. In some embodiments of the present invention, in the above-mentioned step S24, the instruction circuit 162 transmits the display reading instruction to the display device 320 and/or 340 in compliance with Monitor Control Command Set (MCCS) standard (in other words, the display reading instruction is MCCS instruction). In some embodiments of the present invention, in the above-mentioned step S24, the instruction circuit 162 reads back the display parameter signal from the display devices 320 and/or 340 in compliance with Monitor Control Command Set (MCCS) standard. Specifically, some embodiments of the present invention can actually support any function within Monitor Control Command Set (MCCS) standard specifications, such as adjusting color temperature, saturation, Hue, brightness, contrast, volume, etc. The detailed of the functions within Monitor Control Command Set (MCCS) standard specifications can refer to the “VESA Monitor Control Command Set Standard” document of the VESA Association.

The display parameters of the display device are adjusted, for example, by the following steps. First, the steps (S21), (S22), (S23), (S24), (S25) and (S26) are performed so that the external control device 220, 240, or 260 acquires the display parameters of the display device 320 and/or 340 and then decides whether to adjust the display parameters of the display device 320 and/or 340. It is worth mentioning that if the external control device 220, 240 or 260 has confirmed the display parameters of the display device 320 and/or 340 in advance or would like to directly adjust the display parameters of the display device 320 and/or 340, it is not necessary to perform the steps (S21), (S22), (S23), (S24), (S25) and (S26) at first. Then, the following steps are performed. (S31) The external control device 220, 240 or 260 utilizes a corresponding program to transmit an operation instruction (for adjusting the display parameters) to the communication circuit 122. (S32) The instruction translation circuit 124 translates the operation instruction into a third communication protocol message (for adjusting the display parameters). (S33) The processing circuit 142 receives the third communication protocol message (for adjusting the display parameters) and converts the third communication protocol message into a display setting instruction (for adjusting the display parameters). (S34) The processor transmits the display setting instruction (for adjusting the display parameters) to the instruction circuit 162. The instruction circuit 162 transmits the display setting instruction (for adjusting the display parameters) to the display device 320 and/or 340 to adjust the display parameters of the display device 320 and/or 340. It is worth mentioning that the above-mentioned function for obtaining or adjusting the display parameters of the display device may also be to obtain the display parameters of the display device 320 and to write them into the display parameters of the display device 340.

In some embodiments of the present invention, in the above-mentioned step S32, the third communication protocol message is also an I²C signal. In some embodiments of the present invention, in the above-mentioned step S34, the instruction circuit 162 transmits the display setting instruction to the display device 320 and/or 340 in compliance with Monitor Control Command Set (MCCS) standard or Consumer Electronics Control (CEC) protocol (in other words, the display setting instruction is MCCS instruction or CEC instruction). To further explain, when the display device receives the display setting instruction, the display device will control the display parameters of the display device according to the content of the display setting instruction, such as controlling the brightness or contrast of the screen, controlling the volume of the sound unit, or controlling the power of the screen of the display device. Specifically, some embodiments of the present invention can actually support any function within Consumer Electronics Control (CEC) protocol specifications, such as but not limited to: performing one-click play (when the external control device starts playing, the external control device is allowed to switch the input signal source of the display device to be from the external control device), performing system standby (allowing the user to control multiple display devices into standby mode with one click), performing system information (checking the bus addresses and configurations of all display devices), performing volume control (allowing the user to utilize one display device to control the volume of another display device), displaying on-screen display (OSD) menu (displaying text by utilizing the OSD menu function of the display device), performing device menu control (allowing the user to utilize one display device to transmit user interface command to control the system menu of another display device), performing path control (controlling/switching the input signal source of the display device), performing remote control transmission (allowing to transmit a remote control instruction of one external control device to another display device), performing display device name transfer (transmitting a device-friendly name or code to the display device (replaces HDMI 1, HDMI 2, etc.,)).

In some embodiments of the present invention, as shown in FIG. 1, the external control device 240 (e.g., the server), the external control device 260 (e.g., the smart phone) or the network interface controller 120 may also be controlled by the cloud server 400, or the external control device 240 is a cloud server itself, and the above-mentioned operation instruction or reading instruction in the above-mentioned embodiments may be transmitted by the cloud server 400 as the transmitted initiator. In other words, in some embodiments of the present invention, the cloud server 400 may also utilize the server or the smart phone to connects to the docking station 100 through the wireless network so as to remotely control the docking station 100 to perform the above-mentioned operations, such as obtaining the current firmware version of the docking station, obtaining specific firmware operation information of the docking station (for engineering personnel to debug), obtaining the firmware development date of the docking station, updating the firmware of the docking station, obtaining the display parameters of the display device, adjusting the display parameters of the display device, etc.

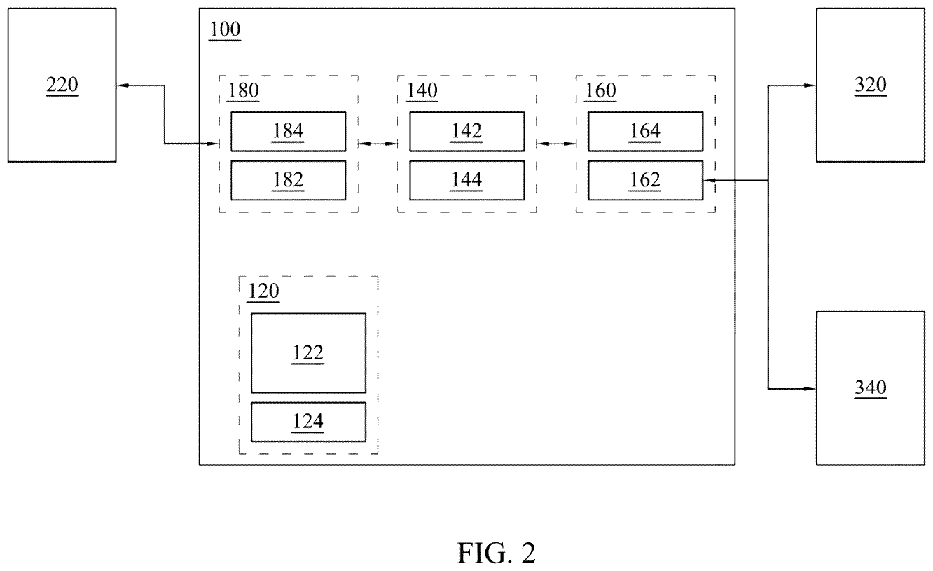

FIG. 2 illustrates a system block diagram of an application system of the docking station 100 according to some embodiments of the present invention. The arrow symbols as shown in FIG. 2 are used to represent the transmission path of the control instructions. FIG. 2 is similar to FIG. 1, and the difference between FIG. 2 and FIG. 1 is that the device that transmits the operation instruction or the reading instruction is the external control device 220 (e.g., the computer) directly connected to the docking station 100 at the near end (for example, through an audio-video transmission line), and the operation instruction or the reading instruction transmitted by the external control device 220 (e.g., the computer) is received by the instruction circuit 182 of the input interface controller 180. The instruction circuit 182 will also translate the operation instruction or the reading instruction transmitted by the external control device 220 (e.g., the computer) into a first communication protocol message or a second communication protocol message, and then transmit the first communication protocol message or the second communication protocol message to the processing circuit 142. In addition, corresponding to the above-mentioned step S13, the processor 140 correspondingly returns the current firmware version message to the external control device 220 (e.g., the computer) through the input interface controller 180, so that the external control device 220 (e.g., the computer) acquires the current firmware version of the docking station 100. In addition, corresponding to the above-mentioned step S26, the input interface controller 180 receives the second communication protocol message from the processor 140 and transmit the second communication protocol message to the external control device 220 (e.g., the computer), so that the external control device 220 (e.g., the computer) acquires the display parameters of the display device 320 and/or 340. The rest of the operations with respect to FIG. 2 are basically similar to the operations with respect to FIG. 1 as described above, and are not repeated here to avoid duplicity. Specifically, FIG. 2 is similar to FIG. 1, except that in FIG. 2, the user uses a computer physically connected to the docking station to remotely control the docking station 100 at near end.

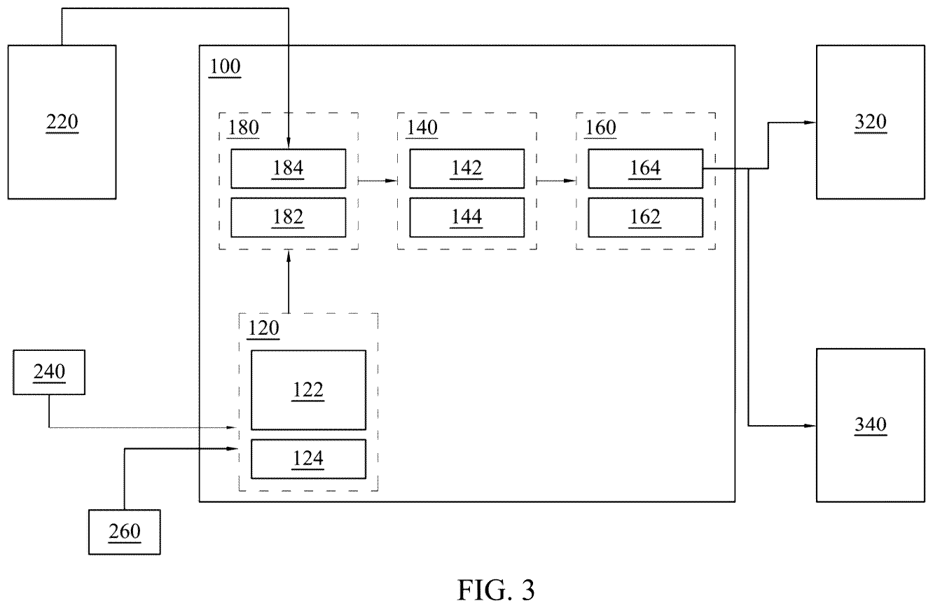

FIG. 3 illustrates a system block diagram of an application system of the docking station 100 according to some embodiments of the present invention. The arrow symbols as shown in FIG. 3 are used to represent the transmission path of the audio-video data. FIG. 3 is similar to FIG. 1, and the difference between FIG. 3 and FIG. 1 is that FIG. 3 is used to illustrate the transmission path of the audio-video data of the application system of the docking station. As shown in FIG. 3, the input interface controller 180 is connected to the electronic device so that the audio-video interface circuit 184 of the input interface controller 180 receives the first audio-video signal from the electronic device. The above-mentioned electronic device is, for example, the external control device 220 (e.g., the computer) physically connected (for example, through an audio-video transmission line) to the input interface controller 180, or the above-mentioned electronic device is, for example, an external control device 240 (e.g., the server) or 260 (e.g., the smart phone) remotely connected to the input interface controller 180 through the network via the communication circuit 122. The audio-video interface circuit 164 of the output interface controller 160 receives the first audio-video signal through the processor 140 and transmits the first audio-video signal to the display device 320 and/or 340, so that the display screen of the display device 320 and/or 340 correspondingly displays an image corresponding to the first audio-video signal.

In the embodiment as shown in FIG. 3, the above-mentioned display setting instruction for adjusting the display parameters of the display device 320 and/or 340 can also be used to control the image displayed on the display screen of the display device 320 and/or 340. For example, the display screen of the display device can also be quickly controlled to be darkened through the display setting instruction, so that the display screen of the specific display device can be controlled to display a darkened screen.

In some embodiments of the present invention, the above-mentioned displaying a darkened screen can be achieved by using different methods, such as: controlling to display a specific color image, controlling to display the image only including a brand logo, controlling to display the image only including a warning message, controlling to display the image only including the user interface (UI) or on-screen display (OSD) menu, controlling to display normally for a short period of time (for example, one minute) to facilitate the user to operate the user interface (UI) or on-screen display (OSD) menu, controlling the output stream to be interrupted, controlling the connection port connected to the display device to be powered off, etc. In other embodiments, the Consumer Electronics Control (CEC) command can be transmitted or the power supply of the docking station (e.g., 5V HDMI power supply) can be disconnected, such that the display device cannot display normally. Alternatively, an instruction can also be transmitted to turn off the backlight unit of the display device.

For example, the above-mentioned displaying a specific color image or the image only including a brand logo, a warning message, the user interface (UI) or on-screen display (OSD) menu can be achieved through the following steps. (S41) The external control device 220, 240 or 260 utilizes a corresponding program to transmit the instruction (for controlling the display screen of the display device) to the communication circuit 122. (S42) The instruction translation circuit 124 translates the instruction into a communication protocol message to control the display screen of the display device. (S43) The processing circuit 142 receives the communication protocol message and converts the first audio-video signal into the second audio-video signal different from the first audio-video signal according to the communication protocol message, and transmits the second audio-video signal to the output interface controller 160. (S44) The audio-video interface circuit 164 transmits the second audio-video signal to the display device 320 and/or 340, so that the display screen of the display device 320 and/or 340 correspondingly displays an image corresponding to the second audio-video signal, such as displaying a specific color image, displaying the image only including a brand logo, displaying the image only including a warning message, displaying the image only including the user interface (UI) or on-screen display (OSD) menu, etc.

For example, the above-mentioned displaying normally for a short period of time to facilitate the user to operate the user interface (UI) or on-screen display (OSD) menu can be achieved through the following steps. (S41) The external control device 220, 240 or 260 utilizes a corresponding program to transmit the instruction (for controlling the display screen of the display device) to the communication circuit 122. (S42) The instruction translation circuit 124 translates the instruction into a communication protocol message to control the display screen of the display device. (S51) In a first period, the processor 140 transmits the first audio-video signal to the output interface controller 160 according to the communication protocol message, and the audio-video interface circuit 164 transmits the first audio-video signal to the display device in the first period, so that the display screen of the display device correspondingly displays an image corresponding to the first audio-video signal. (S52) In a second period subsequent to the first period, the processor 140 transmits the second audio-video signal to the output interface controller 160 according to the communication protocol message, and the audio-video interface circuit 164 transmits the second audio-video signal to the display device in the second time period, so that the display screen of the display device displays an image corresponding to the second audio-video signal. Through the above steps, the display screen of the display device is displayed normally only in the first period to facilitate the user to operate the user interface (UI) or on-screen display (OSD) menu, and in the second period subsequent to the first period, the display screen of the display device is controlled to display a specific color image, a brand logo, a warning message, etc., so that the user cannot normally operate the user interface (UI) or on-screen display (OSD) menu in the second period.

For example, the above-mentioned controlling the display device to display a darkened screen can be achieved through the following steps. (S61) The external control device 220, 240 or 260 utilizes a corresponding program to transmit the instruction (for darkening the display screen of the display device) to the communication circuit 122. (S62) The instruction translation circuit 124 translates the instruction into a communication protocol message (for darkening the display screen of the display device). (S63) The processing circuit 142 receives the communication protocol message and does not transmit the first audio-video signal to the output interface controller 160 according to the communication protocol message, so that the display device does not display, thereby achieving the purpose of displaying a darkened screen.

For example, the above-mentioned displaying normally for a short period of time to facilitate the user to operate the user interface (UI) or on-screen display (OSD) menu can be achieved through the following steps. (S41) The external control device 220, 240 or 260 utilizes a corresponding program to transmit the instruction (for controlling the display screen of the display device) to the communication circuit 122. (S42) The instruction translation circuit 124 translates the instruction into a communication protocol message to control the display screen of the display device. (S51) In a first period, the processor 140 transmits the first audio-video signal to the output interface controller 160 according to the communication protocol message, and the audio-video interface circuit 164 transmits the first audio-video signal to the display device in the first period, so that the display screen of the display device correspondingly displays an image corresponding to the first audio-video signal. (S53) In a second period subsequent to the first period, the processor 140 does not transmit the first audio-video signal to the output interface controller 160 according to the communication protocol message, so that the display screen of the display device displays a darkened screen. Through the above steps, the display screen of the display device is displayed normally only in the first period to facilitate the user to operate the user interface (UI) or on-screen display (OSD) menu, and in the second period subsequent to the first period, the display screen of the display device is controlled to display a darkened screen, so that the user cannot normally operate the user interface (UI) or on-screen display (OSD) menu in the second period.

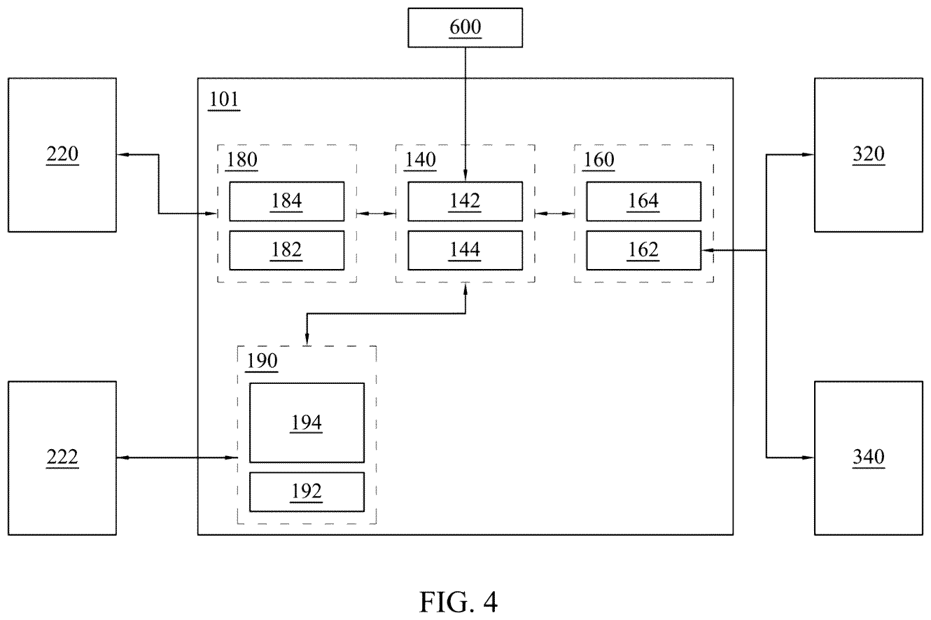

FIG. 4 illustrates a system block diagram of a docking station 101 according to some embodiments of the present invention. The docking station 101 is similar to the docking station 100. The difference between the docking station 101 and the docking station 100 is that the docking station 101 includes two input interface controllers 180 and 190 respectively connected to the first electronic device (i.e., the external control device 220 (i.e., the computer)) and the second electronic device (i.e., the external control device 222 (i.e., the computer)), the audio-video interface circuit 184 of the input interface controller 180 of the docking station 101 receives the first audio-video signal from the first electronic device, and the audio-video interface circuit 194 of the input interface controller 190 of the docking station 101 receives the second audio-video signal from the second electronic device. The processor 140 of the docking station 101 determines whether to transmit the first audio-video signal or the second audio-video signal to the output interface controller 160 according to the control signal transmitted by the switch unit 600 connected to the processor 140, so that the display device 320 and/or 340 displays an image corresponding to the first audio-video signal or the second audio-video signal. The operation instruction or the reading instruction transmitted by the external control device 220 (i.e., the computer) is received by the instruction circuit 182 of the input interface controller 180 of the docking station 101. The instruction circuit 182 also translates the operation instruction or the reading instruction transmitted by the external control device 220 (i.e., the computer) into a first communication protocol message or a second communication protocol message, and then transmits the first communication protocol message or the second communication protocol message to the processing circuit 142 of the processor 140. The operation instruction or the reading instruction transmitted by the external control device 222 (i.e., the computer) is received by the instruction circuit 192 of the input interface controller 190 of the docking station 101. The instruction circuit 192 also translates the operation instruction or the reading instruction transmitted by the external control device 222 (i.e., the computer) into a first communication protocol message or a second communication protocol message, and then transmits the first communication protocol message or the second communication protocol message to the processing circuit 142. The docking station 101 can determine whether to transmit the first communication protocol message or the second communication protocol message from the instruction circuit 182 or the instruction circuit 192 to the output interface controller 160 through the processor 140 or through the switch unit 600.

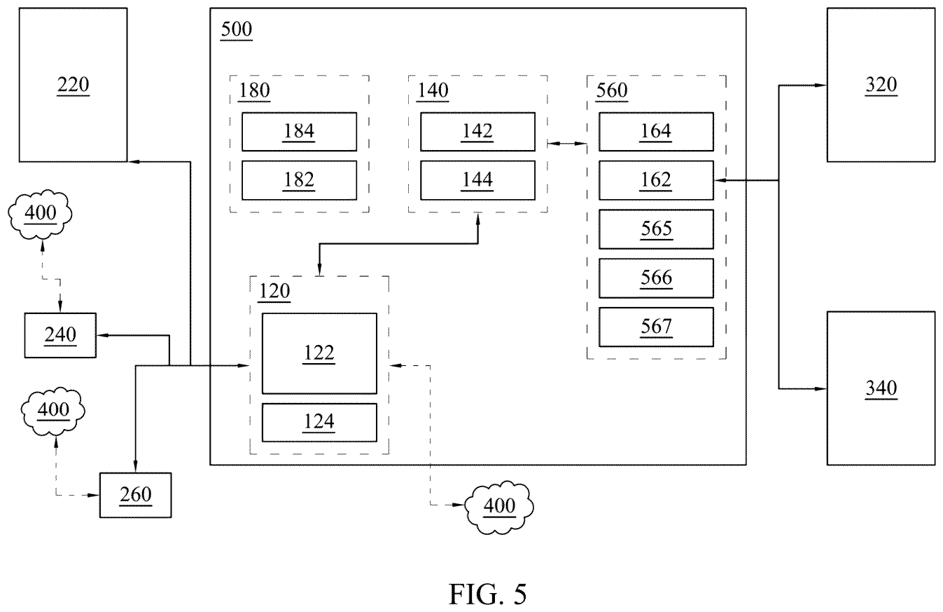

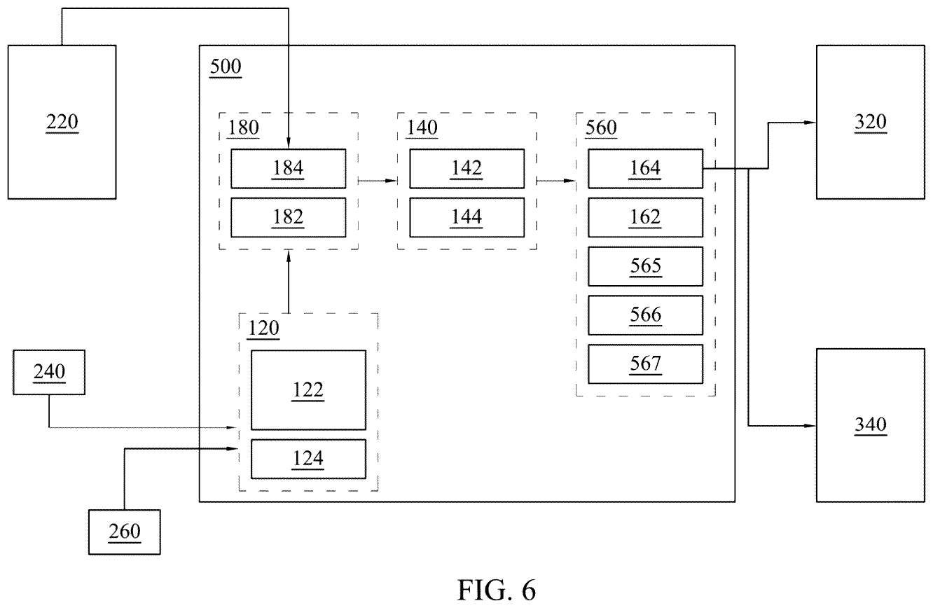

FIG. 5 and FIG. 6 illustrate system block diagrams of an application system of a display device 500 according to some embodiments of the present invention. The arrow symbols as shown in FIG. 5 are used to indicate the transmission paths of the control instructions. The arrow symbols as shown in FIG. 6 are used to indicate the transmission paths of audio-video data. The display device 500 includes a network interface controller 120, a processor 140, a display and output interface controller 560, and an input interface controller 180. Specifically, the display device 500 is a display device with a built-in docking station. The functions of the network interface controller 120, the processor 140, and the input interface controller 180 of the display device 500 in FIG. 5 are similar to the functions of the network interface controller 120, the processor 140, and the input interface controller 180 of the docking station 100 in FIG. 1, and are not repeated here to avoid duplicity.

Specifically, the processor 140 of the display device 500 can also update the firmware of the display device 500 by writing the first protocol message into the memory 144 of the processor 140. Specifically, the processor 140 can also return the current firmware version information to the external control device 220/240/260 through the network interface controller 120, so that the external control device 220/240/260 acquires the current firmware version of the display device 500. The display and output interface controller 560 is electrically connected to the processor 140 of the display device 500. The display and output interface controller 560 of the display device 500 is similar to the output interface controller 160 of the docking station 100, and thus the display and output interface controller 560 can also convert the communication protocol message into a display setting instruction and can transmit the display setting instruction to the display device 320 and/or 340 connected to the display and output interface controller 560 to adjust the display parameters of the display device 320 and/or 340 (i.e., the display device 320 and/or 340 is the external display device of the display device 500).

The difference between the display device 500 and the docking station 100 is that the display and output interface controller 560 of the display device 500 can receive audio-video signal, such that the display screen of the display device 500 displays an image corresponding to the audio-video signal. Specifically, as shown in FIG. 6, the display and output interface controller 560 of the display device 500 includes the instruction circuit 162 and the audio-video interface circuit 164, and the display and output interface controller 560 of the display device 500 also includes a display panel 565, a backlight unit 566 and an audio circuit 567, so that the display device 500 can correspondingly display an image and play a voice corresponding to the audio-video signal.

In embodiment of FIG. 5, the display and output interface controller 560 can also read or adjust the display parameters of the display device 500 by receiving the communication protocol message.

For example, the above-mentioned reading the display parameters of the display device 500 can be achieved through the following steps. (S71) The external control device 220, 240 or 260 utilizes a corresponding program to transmit a reading instruction (for obtaining the display parameters of the display device 500) to the communication circuit 122 of the network interface controller 120. (S72) The instruction translation circuit 124 of the network interface controller 120 translates the reading instruction into a first communication protocol message to obtain the display parameters of the display device 500. (S73) The processing circuit 142 of the processor 140 receives the first communication protocol message (for obtaining the display parameters of the display device 500) and transmits the first communication protocol message to the display and output interface controller 560 to read back the display parameter signal from the display and output interface controller 560. (S74) The processing circuit 142 of the processor 140 translates the display parameter signal into a second communication protocol message. (S75) The communication circuit 122 of the network interface controller 120 receives the second communication protocol message from the processor 140 and transmits the second communication protocol message to the external control device 220, 240 or 260, so that the external control device 220, 240 or 260 acquires the display parameters of the display device 500.

For example, the above-mentioned adjusting the display parameters of the display device 500 can be achieved through the following steps. First, the steps (S71), (S72), (S73), (S74) and (S75) are performed so that the external control device 220, 240, or 260 acquires the display parameters of the display device 500 and then decides whether to adjust the display parameters of the display device 500. It is worth mentioning that if the external control device 220, 240 or 260 has confirmed the display parameters of the display device 500 in advance or would like to directly adjust the display parameters of the display device 500, it is not necessary to perform the steps (S71), (S72), (S73), (S74) and (S75) at first. Then, the following steps are performed. (S81) The external control device 220, 240 or 260 utilizes a corresponding program to transmit the operation instruction (for adjusting the display parameters of the display device 500) to the communication circuit 122 of the network interface controller 120. (S82) The instruction translation circuit 124 of the network interface controller 120 translates the operation instruction into a third communication protocol message (for adjusting the display parameters of the display device 500). (S83) The processing circuit 142 of the processor 140 transmits the third communication protocol message to the display and output interface controller 560 to adjust the display parameters of the display device 500.

In embodiment of FIG. 5, the display device 500 can also can also read or adjust display parameters of the display device 320 and/or 340 by transmitting a display reading instruction or a display setting instruction.

For example, the above-mentioned reading the display parameters of the display device 320 and/or 340 can be achieved through the following steps. (S91) The external control device 220, 240 or 260 utilizes a corresponding program to transmit a reading instruction (for obtaining the display parameters of the display device 320 and/or 340) to the communication circuit 122 of the network interface controller 120. (S92) The instruction translation circuit 124 of the network interface controller 120 translates the reading instruction into a first communication protocol message (for obtaining the display parameters of the display device 320 and/or 340). (S93) The processing circuit 142 of the processor 140 receives the first communication protocol message (for obtaining the display parameters of the display device 320 and/or 340) and converts the first communication protocol message into a display reading instruction (for obtaining the display parameters of the display device 320 and/or 340). (S94) The processing circuit 142 of the processor 140 transmits the display reading instruction (for obtaining the display parameters of the display device 320 and/or 340) to the instruction circuit 162 of the display and output interface controller 560, the instruction circuit 162 of the display and output interface controller 560 transmits the display reading instruction (for obtaining the display parameters of the display device 320 and/or 340) to read back the display parameter signal from the display device 320 and/or 340. (S95) The processing circuit 142 of the processor 140 receives the display parameter signal from the instruction circuit 162 of the display and output interface controller 560 and translates the display parameter signal into a second communication protocol message. (S96) The communication circuit 122 of the network interface controller 120 receives the second communication protocol message from the processor 140 and transmits the second communication protocol message to the external control device 220, 240 or 260, so that the external control device 220, 240 or 260 acquires the display parameters of the display device 320 and/or 340.

For example, the above-mentioned adjusting the display parameters of the display device 320 and/or 340 can be achieved through the following steps. First, the steps (S91), (S92), (S93), (S94), (S95) and (S96) are performed so that the external control device 220, 240, or 260 acquires the display parameters of the display device 320 and/or 340 and then decides whether to adjust the display parameters of the display device 320 and/or 340. It is worth mentioning that if the external control device 220, 240 or 260 has confirmed the display parameters of the display device 320 and/or 340 in advance or would like to directly adjust the display parameters of the display device 320 and/or 340, it is not necessary to perform the steps (S91), (S92), (S93), (S94), (S95) and (S96) at first. Then, the following steps are performed. (S101) The external control device 220, 240 or 260 utilizes a corresponding program to transmit the operation instruction (for adjusting the display parameters of the display device 320 and/or 340) to the communication circuit 122 of the network interface controller 120. (S102) The instruction translation circuit 124 of the network interface controller 120 translates the operation instruction into a third communication protocol message (for adjusting the display parameters of the display device 320 and/or 340). (S103) The processing circuit 142 of the processor 140 receives the third communication protocol message (for adjusting the display parameters of the display device 320 and/or 340) and converts the third communication protocol message into a display setting instruction (for adjusting the display parameters of the display device 320 and/or 340). (S104) The processor 140 transmits a display setting instruction (for adjusting the display parameters of the display device 320 and/or 340) to the instruction circuit 162 of the display and output interface controller 560. The instruction circuit 162 of the display and output interface controller 560 transmits the display setting instruction to the display device 320 and/or 340 to adjust the display parameters of the display device 320 and/or 340.

From the above description, the present invention provides a docking station with a remote control function. An external control device can perform various operations on the docking station through remote control, such as updating the firmware of the docking station, obtaining or adjusting the display parameters of the display device connected to the docking station, etc. The network manager no longer needs to go to the site for individual processing by connecting the docking station through the physical line, thereby saving time and improving management efficiency.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A docking station, comprising:
a network interface controller configured to receive an operation instruction from an external control device and correspondingly translate the operation instruction into a first communication protocol message;
a processor connected to the network interface controller to receive the first communication protocol message; and
an output interface controller connected to the processor;
wherein the processor is configured to perform the following operations according to the first communication protocol message:
writing the first communication protocol message corresponding to a firmware file into a memory of the processor so as to update firmware of the docking station; or
transmitting the first communication protocol message to the output interface controller, such that the output interface controller converts the first communication protocol message into a display setting instruction and transmits the display setting instruction to at least one display device connected to the output interface controller so as to adjust at least one display parameter of the at least one display device.

2. The docking station of claim 1, wherein the external control device is a computer, a server or a smart phone, wherein a transmission interface between the external control device and the network interface controller is a wireless communication interface, an Ethernet interface, a serial interface, a USB interface or an audio-video transmission line interface, wherein the network interface controller transmits the first communication protocol message to the processor in compliance with a communication interface.

3. The docking station of claim 2, wherein the communication interface is an inter-integrated circuit (I²C) protocol.

4. The docking station of claim 2, wherein the communication interface is auxiliary (AUX) interface, Display Data Channel/Command Interface (DDC/CI), Universal Asynchronous Receiver/Transmitter (UART), Serial Peripheral Interface (SPI), Power Delivery Configuration Channel (PD CC), CAN bus, Modbus protocol, Consumer Electronics Control (CEC) protocol, or USB interface.

5. The docking station of claim 1,
wherein the network interface controller is further configured to receive a reading instruction from the external control device and correspondingly translate the reading instruction into a second communication protocol message,
wherein the processor is configured to perform the following operations according to the second communication protocol message:
sending back, through the network interface controller, a firmware information message to the output interface controller, such that the external control device obtains current firmware information of the docking station; or
transmitting, by the processor, the second communication protocol message to the output interface controller, such that the output interface controller converts the second communication protocol message into a display reading instruction and transmits the display reading instruction to the at least one display device so as to read the at least one display parameter of the at least one display device from the at least one display device.

6. The docking station of claim 5, wherein the current firmware information includes at least one of: a firmware version, a firmware operation information, and a firmware development date.

7. The docking station of claim 1, wherein the output interface controller transmits the display setting instruction to the at least one display device to adjust the at least one display parameter of the at least one display device in compliance with Video Electronics Standards Association (VESA) Monitor Control Command Set (MCCS) standard or CEC protocol.

8. The docking station of claim 5, wherein the output interface controller transmits the display reading instruction to the at least one display device to read the at least one display parameter of the at least one display device in compliance with VESA MCCS standard.

9. The docking station of claim 1, further comprising:
a first input interface controller configured to receive a first audio-video signal from a first electronic device connected to the first input interface controller; and
a second input interface controller configured to receive a second audio-video signal from a second electronic device connected to the second input interface controller;
wherein the processor is further configured to determine whether to transmit the first audio-video signal or the second audio-video signal to the output interface controller according to a control signal transmitted by a switch connected to the processor, such that the at least one display device displays an image corresponding to the first audio-video signal or the second audio-video signal.

10. A docking station, comprising:
a network interface controller configured to receive an operation instruction from an external control device and correspondingly translate the operation instruction into a first communication protocol message;
a processor connected to the network interface controller to receive the first communication protocol message;
an output interface controller connected to the processor; and
an input interface controller connected an electronic device to receive a first audio-video signal from the electronic device;
wherein the processor is configured to convert the first audio-video signal into a second audio-video signal different from the first audio-video signal according to the first communication protocol message and to transmit the second audio-video signal to the output interface controller;
wherein the output interface controller transmits the second audio-video signal to at least one display device connected to the output interface controller, such that the at least one display device displays an image corresponding to the second audio-video signal.

11. The docking station of claim 10, wherein the processor is further configured to:
during a first period, transmit the first audio-video signal to the output interface controller according to the first communication protocol message, such that the at least one display device displays the image corresponding to the first audio-video signal; and
during a second period subsequent to the first period, transmit the second audio-video signal to the output interface controller according to the first communication protocol message, such that the at least one display device displays the image corresponding to the second audio-video signal.

12. The docking station of claim 10, wherein the processor is further configured to not transmit the first audio-video signal to the output interface controller according to the first communication protocol message, such that the at least one display device does not display the image.

13. The docking station of claim 10, wherein the processor is further configured to:
during a first period, transmit the first audio-video signal to the output interface controller according to the first communication protocol message, such that the at least one display device display the image corresponding to the first audio-video signal; and
during a second period subsequent to the first period, not transmit the first audio-video signal to the output interface controller according to the first communication protocol message, such that the at least one display device does not display the image.

14. A display device, comprising:
a network interface controller configured to receive an operation instruction from an external control device and correspondingly translate the operation instruction into a first communication protocol message;
a processor connected to the network interface controller to receive the first communication protocol message; and
a display and output interface controller connected to the processor;
wherein the processor is configured to transmit the first communication protocol message to the display and output interface controller, such that the display and output interface controller converts the first communication protocol message into a display setting instruction and transmits the display setting instruction to an external display device connected to the display and output interface controller so as to adjust at least one display parameter of the external display device.

15. The display device of claim 14, wherein the external control device is a computer, a server or a smart phone, wherein a transmission interface between the external control device and the network interface controller is wireless communication interface, Ethernet interface, serial interface, USB interface or audio-video transmission line interface, wherein the network interface controller transmits the first communication protocol message to the processor in compliance with an inter-integrated circuit (I²C) protocol.

16. The display device of claim 14, wherein the display and output interface controller transmits the display setting instruction to the external display device to adjust the at least one display parameter of the external display device in compliance with VESA MCCS standard or CEC protocol.

17. The display device of claim 14,
wherein the network interface controller is further configured to receive a reading instruction from the external control device and correspondingly translate the reading instruction into a second communication protocol message,
wherein the processor is configured to transmit the second communication protocol message to the display and output interface controller, such that the display and output interface controller converts the second communication protocol message into a display reading instruction and transmits the display reading instruction to the external display device so as to read the at least one display parameter of the external display device from the external display device.

18. The display device of claim 17, wherein the display and output interface controller transmits the display reading instruction to the external display device to read the at least one display parameter of the external display device in compliance with VESA MCCS standard.

19. The display device of claim 14, wherein the first communication protocol message transmitted to the display and output interface controller is further used to adjust at least one display parameter of the display device.

20. The display device of claim 17, wherein the processor is further configured to read at least one display parameter of the display device according to the second communication protocol message.
